(19) United States
(12) Patent Application Publication
(10) Pub. No.: US 2026/0082194 A1
(43) Pub. Date: Mar. 19, 2026

(54) METHODS AND DEVICES TO PERFORM SHORT-RANGE WIRELESS COMMUNICATION

(71) Applicant: INTEL CORPORATION, Santa Clara, CA (US)

(72) Inventor: Ehud RESHEF, KIRYAT TIVON (IL)

(21) Appl. No.: 18/888,323

(22) Filed: Sep. 18, 2024

(51) Int. Cl. H04W 4/80; H04W 76/10

(52) U.S. Cl. CPC H04W 4/80; H04W 76/10

(57) ABSTRACT

An apparatus of a Bluetooth (BT) communication device, the apparatus may include a memory, and a processor configured to: communicate with a peripheral device via an established BT connection between the BT communication device and the peripheral device; identify a further BT communication device that is connectable to the peripheral device; and instruct, via the established BT connection, the peripheral device to enter a discovery mode.

### TECHNICAL FIELD

This disclosure generally relates to methods and apparatus to perform short-range wireless communication.

### BACKGROUND

Short-range wireless communication is a commonly used technology that allows the transmission of data over short distances. It is often used in different devices, such as mobile devices, computers, audio devices, and additional devices, to enable easy connectivity and data exchange. The communication protocol defines a set of standards for connecting devices, establishing links, and managing data transfer processes to ensure reliable and secure communication. Despite its versatility and widespread use, there are ongoing difficulties related to effectively managing connections, connecting multiple devices, and ensuring optimal performance and user experience. These difficulties require ongoing innovation and improvement in the field of communication technology.

BT, as a short-range wireless communication technology, encompasses two primary variants: Classic BT and BT Low Energy (BLE). Classic BT is generally designed for continuous, high-throughput data transmission, mainly for applications in audio streaming, hands-free calling, and wireless communication in computer peripherals such as keyboards and mice. On the other hand, BLE may focus on providing efficient, low-power wireless communication designed for intermittent connections and small data transfers. A critical aspect of modern BT technology may be the ability to seamlessly transfer connections for a peripheral device between two central devices to ensure that the peripheral device, can maintain continuous and uninterrupted service while switching from one central device to another, for instance, from a smartphone to a laptop. This seamless connection transfer may be vital for enhancing user experience and ensuring the reliability and flexibility of wireless ecosystems in dynamic environments.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an exemplary illustration of a network environment;

FIG. 4 shows an exemplary illustration of a network topology that communication devices may use;

FIG. 5 shows an illustrative example of a communication device;

FIG. 6 shows an illustrative example of a system in accordance with various aspects described herein;

FIG. 7 shows an example of a flow chart to establish a new connection;

FIG. 8 shows an example of a method;

FIG. 9 shows an example of a method;

FIG. 10 shows an example of a method.

### DESCRIPTION

The following detailed description refers to the accompanying drawings that show, by way of illustration, exemplary details and aspects in which aspects of the present disclosure may be practiced.

Aspects are described in this disclosure in the context of BT technology, they may also apply to various other short-range wireless communication technologies, such as Wi-Fi Direct, Wi-Fi Aware, WiGig, Ultra-Wideband (UWB) and other such existing, developing or to be developed technologies. Aspects described herein relates to solving challenges associated with the current or traditional techniques, which provide non-optimal usability and cost prohibitive approaches associated with peripherals (e.g. BT peripherals) that support pairing and operation with multiple central devices. These peripherals may require additional memory to store credentials for multiple paired devices and often include physical buttons or other means to select the active compute platform. Some of the aspects described herein aims to enable seamless operation with multiple central devices for any peripheral device, eliminating the need for multiple pairings and reducing device cost.

Traditional methods for pairing of BT devices generally involve peripheral devices with memory and pairing schemes for multiple central devices, physical buttons for selecting the active connection, or software-based control of peripheral connections. For example, a headset may connect to multiple centrals and transition to an active state with the first central initiating a voice call. Software on the main central can direct the peripheral to connect to a pre-paired device, and mouse control software can define transitions based on pointer movement.

Through some of the aspects described herein, multi-central usability may be extended to all peripheral devices. Instead of supporting multiple pairings, a peripheral device may only need to operate with a single pairing/connection. The aspects described herein may leverage existing capabilities, some of which may include proprietary techniques such as Microsoft Swiftpair, Samsung Quick Connect, or Google Fast Pair, to automatically pair with supporting centrals. Aspects described for a system including at least two central devices and a peripheral device may facilitate the transition between central devices through collaboration between the two central devices, both equipped with an application layer software that operates with the BT protocol stack, such as Intel Unison software or similar solutions. In some examples, the transition trigger can be user-defined, such as a hotkey or GUI-driven control.

Some of the aspects described herein may allow users to use fewer peripheral devices across their PCs, tablets, and smartphones, as well as reducing the cost of peripherals that seamlessly work with multiple central devices. Aspects described herein may include a new flow controlled by software on a central device, where the software may implement a method to force a paired and connected peripheral to disconnect and unpair from the current device and pair and connect to a designated other device. In some examples, to address potential security concerns, authentication/verification mechanisms may be implemented on the peripheral and central devices.

In accordance with various aspects described herein, a BT communication device may take the role of a central device and may communicate with a peripheral device via an established BT connection between the BT communication device and the peripheral device and identify a further BT communication device that is connectable to the peripheral device to instruct the peripheral device to enter a discovery mode and/or pair with the further BT communication device, which may result in an enhanced user experience by enabling seamless connectivity management, allowing the primary BT communication device to facilitate the discovery of additional devices without user intervention, increased efficiency in establishing connections with multiple devices, as the primary device can proactively identify and manage potential connections with further BT devices, and improved flexibility by allowing the primary device to control the peripheral's discovery mode, potentially reducing the time and effort required for pairing with new devices. Such an apparatus may enhance connectivity by allowing communication with peripheral devices via a BT connection, increase automation by instructing the peripheral device to enter a discovery mode and/or pair with the further BT communication device, eliminating the need for manual intervention, enable modularity by identifying and connecting with further BT communication devices, expanding the capabilities of the apparatus, allow for attachability by encoding information representative of the further BT communication device for transmission to the peripheral device, facilitating seamless pairing, and may promote synergy by implementing application layer software that interacts with the BT protocol stack, enabling efficient communication and coordination with the further BT communication device.

In accordance with various aspects described herein, a BT communication device may take the role of a peripheral device and may decode information received from a first central device via an established BT connection between the BT communication device and the first central device, in which the information is representative of a presence of a second central device, and it may enter a discovery mode to be discoverable by the second central device and to have established a further BT connection with the second central device. This may enhance the user experience by seamlessly transitioning between multiple central devices, ensuring continuous connectivity and interaction without or with minimal user intervention, improve the efficiency of the BT communication device by automating the process of discovering and connecting to new central devices, thereby reducing the time and effort required for manual connection management, and enable the BT device to dynamically respond to changes in the environment and or user preferences, such as the presence of a preferred or stronger central device, which can lead to improved connection stability and performance.

In accordance with various aspects described herein, a BT communication device may operate as a central device and may establish a first connection to communicate with a further BT communication device via a first communication interface, and decode information representing a presence of a peripheral device received via the first communication interface, and configure, in response to the information, a second communication interface, which is a BT communication interface, to discover the peripheral device to establish a second connection that is a BT connection with the peripheral device. This may result in versatile pairing options and enhances the apparatus's connectivity capabilities, and improve user experience by automating the connection process. The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Although aspects are described in this disclosure in the context of BT technology, they may also apply to various other short-range wireless communication technologies, such as Wi-Fi Direct, Wi-Fi Aware, WiGig, Ultra-Wideband (UWB) and other such existing, developing or to be developed technologies.

The apparatuses and methods described herein may use such radio communication technologies according to various spectrum management schemes, including, but not limited to, dedicated licensed spectrum, unlicensed spectrum especially in 900 MHz, 2.4 GHz, 5.15-5.33 GHz, 5.49-5.895 GHz and 5.925-7.125 GHz (with a potential future expansion to 7.25 GHz), as well as 45 GHz (China) and 60 GHz (worldwide) unlicensed bands, and any future unlicensed band, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology. Short Range radio communication technologies may include Bluetooth, WLAN (e.g., according to any IEEE 802.11 standard), and other similar radio communication technologies including Wireless Personal Area Network (WPAN) standards (e.g., according to any IEEE 802.15 standard), Wi-Fi Direct., and other similar radio communication technologies.

BT technology may use frequencies between 2.402 and 2.480 GHz, or 2.400 and 2.4835 GHz including guard bands 2 MHz wide at the bottom end and 3.5 MHz wide at the top, according to frequency-hopping spread spectrum. There are also discussions to include the 5 GHz and 6 GHz unlicensed bands (5150-5895 MHz, and 5925-6425 MHz). A communication device operating according to a BT protocol may divide data to be transmitted into packets and transmit each packet into a channel designated for the use (e.g. of bandwidth of 1 MHz for classic BT and 2 MHz for BT Low Energy (BLE)). A communication device configured to operate according to a BT protocol may operate in a basic rate (BR) mode using a Gaussian frequency-shift keying (GFSK) modulation, and/or operate in an enhanced data rate (EDR) mode, that is considered to provide a faster data rate and lower power consumption, using a differential phase-shift keying (DPSK) (e.g. 8-DPSK) and/or differential quadrature phase-shift keying (DQPSK) (e.g. π/4-DQPSK) based on the quality of the communication channel. A communication device configured to operate according to a BT protocol may operate according to the BT Low Energy (BLE) technology that is integrated within the BT standard starting from v4.0, which operates within the same frequency spectrum, using GFSK modulation.

Wi-Fi Direct technology, which may also be referred to as Wi-Fi P2P, may be one of the exemplary technologies used with respect to peer-to-peer connections provided in this disclosure. Peer-to-peer connections may refer to point-to-point connections between two communication devices according to a peer-to-peer communication protocol. Within a peer-to-peer network, communication devices (two or more) may communicate with each other over the P2P connections established between them. A Wi-Fi Direct connection may allow communication devices to communicate over an established Wi-Fi Direct connection without an intermediary entity such as an access point or a router. Wi-Fi Direct technology allows for forming a P2P network by forming a P2P group in which a communication device may take the role of a Group Owner (GO) or a Group Client (GC).

Wi-Fi Aware technology, which may also be referred to as Neighbor Awareness Networking (NAN), may be one of the exemplary technologies used with respect to peer-to-peer connections provided in this disclosure. A Wi-Fi Aware connection may allow communication devices to discover and connect directly to each other without the need for an access point, router, or even an active internet connection. Wi-Fi Aware technology enables devices to continuously discover other devices and services within Wi-Fi range prior to establishing a connection, making it easy to find nearby information and services that match user-set preferences. Unlike Wi-Fi Direct which requires a centralized coordinator called a Group Owner, Wi-Fi Aware creates decentralized, dynamic peer-to-peer connections that seamlessly adapt to changing environments and usage conditions

In accordance with various aspects of this disclosure, a communication device may communicate with at least one further communication device. In some aspects, a short-range wireless communication device may communicate with at least one further short-range wireless communication device over an established short-range wireless communication link. The short-range wireless communication device may have connections that are established with multiple short-range wireless communication devices simultaneously. Various aspects provided herein may include examples in which short-range wireless communication is BT communication and accordingly in respective aspects, a short-range wireless connection may include BT connections. Operations may include BT communication in a BR/EDR mode or in a BLE mode, which may include a high data throughput (HDT) mode.

In some aspects, methods and apparatus may employ various configuration mechanisms associated with established synchronous links in BT, particularly for audio connections in some examples, with an intention to reduce power consumption and use of the allocated spectrum efficiently, which may further reduce interference for other BT devices within the same environment.

In some aspects, methods and apparatus may employ various accessibility mechanisms with the intention to improve accessibility of a computing device for visually impaired users. It may be desirable for a computing device to operate in a designated mode with an improved accessibility over an established interface between a designated input device and applications, and in some aspects in designated low power operation modes with an intention to conserve power.

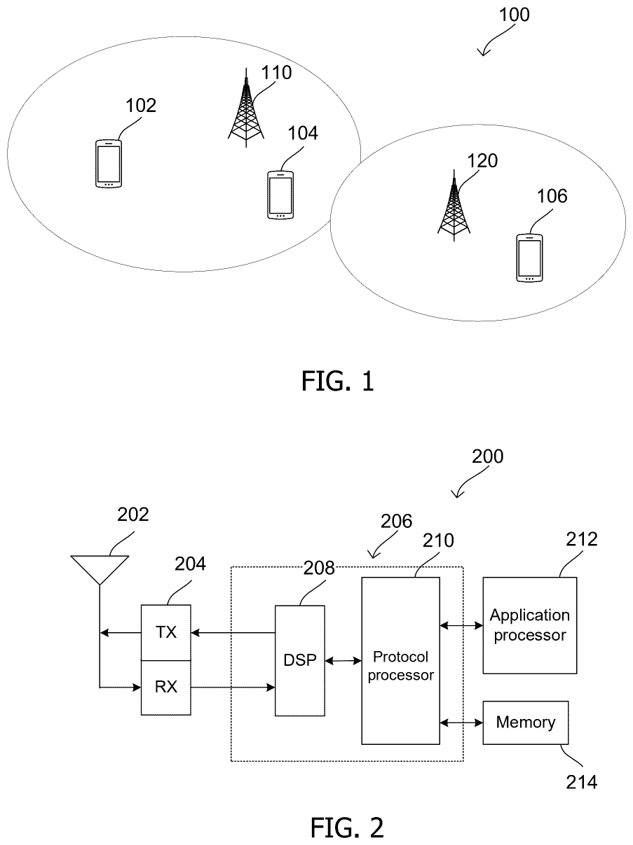

FIGS. 1 and 2 depict a general network and device architecture for wireless communications. In particular, FIG. 1 shows exemplary radio communication network 100 according to some aspects, which may include communication devices depicted as terminal devices 102, 104, and 106 and communication devices depicted as network access node 110. Radio communication network 100 may communicate with terminal devices 102 and 104 via network access node 110 over a radio access network. In an exemplary short-range wireless context other than BT, network access node 110 and 120 may be access points (APs, e.g., WLAN or WiFi APs), while terminal device 102 and 104 may be short range terminal devices (e.g., stations (STAs)). Network access node 110 may interface (e.g., via an internal or external router) with one or more external data networks. Network access node 110 and terminal devices 102 and 104 may include one or multiple transmission/reception points (TRPs). In an exemplary BT network, network access node 110 and 120 may be a primary device of the BT network (e.g. piconet) and terminal devices 102 and 104 may be a secondary device of the BT network.

Network access node 110 (and, optionally, other network access nodes of radio communication network 100 not explicitly shown in FIG. 1) may accordingly provide a radio access network to terminal devices 102, 104, and 106 (and, optionally, other terminal devices of radio communication network 100 not explicitly shown in FIG. 1). In an exemplary short-range context, the radio access network provided by network access node 110 may provide access to internal data networks (e.g., for transferring data between terminal devices connected to radio communication network 100) and external data networks (e.g., data networks providing voice, text, multimedia (audio, video, image), and other Internet and application data).

The radio access network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access node 110 may follow the defined communication protocols to transmit and receive data over the radio access network domain of radio communication network 100. Exemplary communication protocols include BT, WiFi, etc., any of which may be applicable to radio communication network 100.

FIG. 2 shows an exemplary internal configuration of a communication device. The communication device may include a terminal device 102 according to some aspects, and it will be referred to as terminal device 102, but the communication device may also include various aspects of network access nodes 110, 120 as well. The terminal device 102 may include antenna system 202, radio frequency (RF) transceiver 204, baseband modem 206 (including digital signal processor 208 and protocol controller 210), application processor 212, and memory 214. Although not explicitly shown in FIG. 2, in some aspects terminal device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Terminal device 102 may transmit and receive radio signals on one or more radio access networks. Baseband modem 206 may direct such communication functionality of terminal device 102 according to the communication protocols associated with each radio access network and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of terminal device 102 shown in FIG. 2 depicts only a single instance of such components.

Terminal device 102 may transmit and receive wireless signals with antenna system 202. Antenna system 202 may be a single antenna or may include one or more antenna arrays that each include multiple antenna elements. For example, antenna system 202 may include an antenna array at the top of terminal device 102 and a second antenna array at the bottom of terminal device 102. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204. In some examples the TX path may include direct digitally modulated power amplifier instead of analog TX architecture described above.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Terminal device 102 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of terminal device 102 (antenna system 202, RF transceiver 204, and digital signal processor 208) in accordance with the communication protocols of each supported radio communication technology.

Protocol controller 210 may be structurally embodied as a protocol processor configured to execute protocol stack software (retrieved from a controller memory) and subsequently control the radio communication components of terminal device 102 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio terminal device 102 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

In wireless local area network (WLAN) context, the protocol processor 210 may perform protocol stack functions of an IEEE 802.11 communication protocol stack in accordance with any known version of the protocol. In BT context, the protocol processor 210 may perform protocol stack functions of a BT communication protocol.

Terminal device 102 may also include application processor 212 and memory 214. Application processor 212 may be a CPU and may be configured to handle the layers above the protocol stack, including the transport and application layers. Application processor 212 may be configured to execute various applications and/or programs of terminal device 102 at an application layer of terminal device 102, such as an operating system (OS), a user interface (UI) for supporting user interaction with terminal device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of terminal device 102, such as a hard drive or another such permanent memory device. Although not explicitly depicted in FIG. 2, the various other components of terminal device 102 shown in FIG. 2 may additionally each include integrated permanent and non-permanent memory components, such as for storing software program code, buffering data, etc.

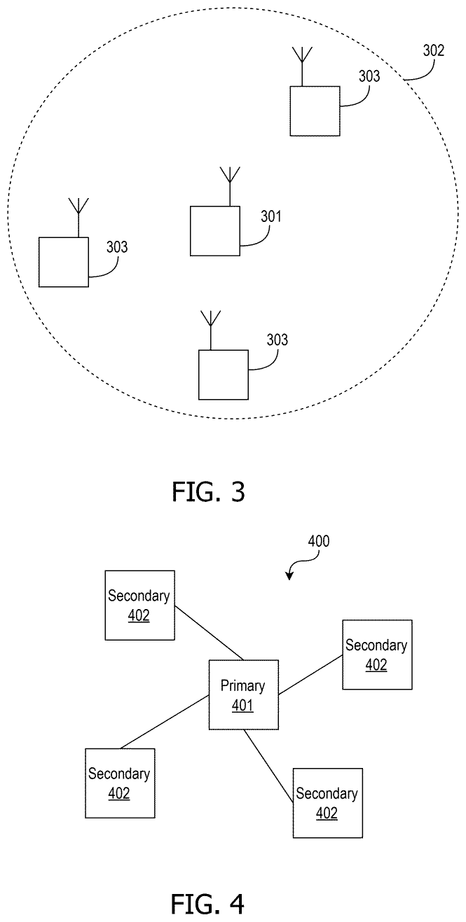

FIG. 3 shows an exemplary illustration of a network environment including various types of communication devices in accordance with various aspects of this disclosure. The network environment is depicted as an example of a BT network including BT devices configured to communicate with BT signals using BT links (i.e. connections) established in-between. The network 300 may include a BT device 301 that is communicatively couplable to various types of communication devices 303 within a coverage area 302 using BT technology. In various examples, the BT device 301 may communicate with further BT devices 303 using BT communication. In this illustrative example, the BT device 301 may be configured to operate as a primary BT device, and further BT devices 303 may be configured to operate as a secondary BT device. Each of the BT device 301 and further BT devices 303 depicted herein may a communication device described in accordance with FIG. 2.

In accordance with various aspects provided herein, the BT technology may include BR/EDR (Basic Rate/Enhanced Data Rate) BT (i.e. classic BT), or BLE (Low Energy). Accordingly, BT devices 301, 303 depicted herein may include at least one BT controller that is configured to perform operations according to BR/EDR BT and/or BLE.

In accordance with the BR/EDR BT technology, BT devices 301, 303 within the network 300 may share a physical communication channel that is shared. The primary BT device (i.e. the BT device 301) may synchronize the secondary BT devices (i.e. further BT devices 303) with a synchronization reference (a common clock and frequency hopping pattern). The primary BT device and the secondary BT devices may perform communication operations according to the synchronization reference (e.g. according to common clock and frequency hopping pattern provided by the primary BT device). The physical communication channel is divided into time slots, and BT devices 301, 303 may transmit and/or receive BT signals using time-division duplex (TDD) operation. It is to be noted that the term primary device may be used interchangeably with central device and the term secondary device may be used interchangeably with peripheral device.

In accordance with the BLE technology, the primary BT device (i.e. the BT device 301, “initiator”) may monitor and receive advertising packets from the secondary BT devices (i.e. the BT devices 303) within the network 300, and, in response to advertisement operations, initiate connection events (exchange of data) over the established physical channel. The primary BT device may provide the frequency hopping pattern to be used for the established connection.

In these technologies, a physical link may be formed between the primary BT device and a secondary BT device for each secondary BT device to facilitate the exchange of data between the primary BT device and the respective secondary BT device. Each physical link may be used by the primary BT device or the respective secondary BT device as a transport for one or more logical links in-between the BT devices respectively. At a receive operation from a BT device, data traffic on a physical link may be demultiplexed to the one or more logical links, and at a transmit operation to a BT device, data traffic on one or more logical links may be multiplexed to the physical link.

A BT device may provide functions to control and manage aspects associated with baseband operations and physical layer operations at a link layer, that is associated with the one or more logical links. The BR/EDR BT device may perform link manager protocol (LMP) functions within the protocol stack, which may use an asynchronous connection-oriented logical transport (i.e. ACL) via LMP protocol signaling. Furthermore, the BR/EDR BT device may perform functions to process synchronous data streams. Similarly, the BLE device may perform link layer protocol (LLP) functions (i.e. the link layer functions) within the protocol stack, which may use an LE asynchronous connection logical transport (i.e. LE ACL). Both BR/EDR BT and BLE may further include logical layer control and adaptation protocol (L2CAP) functions including channel-based abstraction for application layer, segmentation, and reassembly of application data, and multiplexing and de-multiplexing of multiple channels over a shared logical link, etc.

A BT device may further include additional protocols that are interoperable with the BR/EDR and/or LE technologies based on the capabilities of the respective BT device and its intended use. Additional protocols may include various predefined BT profiles (i.e. services, functions) supported by the BT technology, some of which may reside in a layer that is above the layers of the protocol stack mentioned above. For each profile, BT devices performing communication based on a profile may be configured to perform various functions of the respective profile to exchange data associated with the respective profile.

For example, in accordance with various aspects provided herein, a BT device may be configured to perform advanced audio distribution profile (A2DP) functions based on defined A2DP operations (e.g. Advanced Audio Distribution Profile—Bluetooth® Profile Specification, v1.4, 2022 Jun. 21). The A2DP may include various functions associated with streaming (i.e. transferring) audio data from one BT device to another BT device over a BT connection. In accordance with various aspects provided herein, a BT device may perform A2DP functions to receive and/or decode and/or send and/or encode audio data. The A2DP functions may include controlling the processing of audio data based on predefined audio decoding and encoding operations, such as low-complexity subband codec (SBC), MPEG-1, MPEG-2, and MPEG-4, etc.

A2DP functions may be based on functions of further defined protocols (e.g. Audio/Video Distribution Transport Protocol (AVDTP; Audio/Video Distribution Transport Protocol Specification, Bluetooth® Specification, v.13, 2012 Jul. 24), and/or Generic Audio/Video Distribution Profile (GAVDP; Generic Audio/Video Distribution Profile Specification, Bluetooth® Specification, v.13, 2012 Jul. 24)) for distribution of the audio data. In various examples, a BT device may perform AVDTP functions or GAVDP functions to receive and/or decode and/or send and/or encode audio data. A BT device configured to perform functions by which the BT device assumes a designated role to perform functions to decode/encode audio data. A BT device may be configured to operate as a source device, which encodes digital audio data stream to provide the encoded audio data to a sink device of a network. A BT device may be configured to operate as a sink device, which receives encoded digital audio data stream from a source device of a network.

For example, in accordance with various aspects provided herein, a BT device may be configured to perform audio/video remote control profile (AVRCP) functions based on defined AVRCP operations (e.g. Audio/Video Remote Control—Bluetooth® Profile Specification, v1.6.2, 2019 Jan. 21). The AVCRP may include various functions associated with controlling audio/video functions of a BT device by another BT device over a BT connection. In accordance with various aspects provided herein, a BT device may perform AVCRP functions to receive and/or decode and/or send and/or encode messages including information about audio/video operations and control of the audio/video operations. In various examples, such operations may include providing messages that may cause the BT device to display information and receive user interactions.

AVRCP functions may be based on functions of further defined protocols (e.g. Audio/Video Control Transport Protocol (AVCTP; Audio/Video Control Transport Protocol Specification—Bluetooth® Profile Specification, V14, 2012 Jul. 24)) for controlling audio and/or video operations of a BT device. In various examples, a BT device may be configured to perform AVCTP functions to control audio and/or video operations of another BT device via a BT connection.

For example, in accordance with various aspects provided herein, a BT device may be configured to perform headset profile (HSP) functions based on defined HSP operations (i.e. Headset Profile—Bluetooth® Profile Specification, v12r00, 2008 Dec. 18) or hands-free profile (HFP) functions based on defined HFP operations (i.e. Hands-Free Profile—Bluetooth® Profile Specification; v1.8, 2020-0414). The HSP or HFP may include various functions associated with controlling audio/video functions particularly related to a headset or hands-free operations of a BT device by another BT device over a BT connection. In accordance with various aspects provided herein, a BT device may perform HSP or HFP functions to receive and/or decode and/or send and/or encode messages including information about headset or hands-free operations. In various examples, such operations may include providing messages including information about calls and voice related data transfer.

HSP or HFP functions may be based on functions of further defined protocols. Furthermore, functions according to A2DP, AVCTP, GAVDP, AVCRP may include operations based on asynchronous connection-oriented logical transport (ACL) communication links. A BT device that may perform HSP and/or HFP functions may be configured to operate using synchronous connection-oriented (SCO) and/or enhanced synchronous connection-oriented (e-SCO) communication links.

A BT device may be configured to communicate using ACL links or SCO links (including e-SCO links unless indicated otherwise). An ACL link may be a packet oriented link, generally used for data traffic between BT devices in which data integrity is desired. An SCO link may include radio links that are generally used for time-critical data communication, such as voice data. To avoid any misunderstanding, a BT device may be configured to operate according to any one or any combination of the profiles mentioned herein using communication links as supported for the profiles respectively. For example, it is common for a BT headset to be configured to operate by performing A2DP, AVCRP, HSP, and HFP functions. Dependencies and positions in the protocol stack associated with each above-mentioned profiles may vary due to flexibility of BT specification to support various use cases.

In various aspects provided herein, in particular within the context of communication between BT BLE Device, the respective BT BLE Devices may stream audio data via one or more isochronous connections using an isochronous physical channel. BT BLE Devices may transfer isochronous audio data in-between using a logical transport. Such streams may be referred to as a Connected Isochronous Stream (CIS). In accordance with various aspects, the CIS may be used to stream audio. In various examples, the communication link may be the logical link transporting the CIS between BT BLE devices.

In various examples, the BT device 301 may communicate with multiple further BT devices 303 within the BT network over established communication links between BT devices that are maintained simultaneously in the network 300. For example, the BT device 301 may be communicatively coupled to each of further BT devices 303 over established connections.

Establishing a BT connection between BT devices may be realized once the BT devices are aware of each other. The primary device may receive an indication of a communication device with the response, which the primary device may use to establish a connection using an identifier of a secondary device. BT devices may store identifiers of other BT devices in their respective memories. BT technology supports pairing, in which two communication devices that are paired with each other may establish a connection with each other. For this purpose, BT devices may exchange a previously defined pairing code (e.g. passkey, password, personal identification number (PIN) that may be designated by the end of the inquiry) to establish a previously paired connection between devices to provide a secure connection.

Once the devices have the necessary information (e.g. identifiers, passphrase, clock, etc.) obtained through an inquiry phase to establish connections, the primary device may initiate a paging procedure, in which the primary device may transmit radio communication signals that are encoded based on the obtained information with respect to the secondary device. In response to a series of exchanged messages according to the paging procedure, which may include the identifier of the secondary device, a connection may be established between the primary device and the secondary device.

In accordance with various aspects of this disclosure, communication devices may exchange data in various modes. As indicated before, BT communication may support a mode in which asynchronous connection-less (ACL) protocol is used. The ACL protocol may include exchanging data frames between communication devices over an established communication, in which the data frames are designated for the purpose of exchanging data. ACL protocol may support retransmissions. BT communication may further support a mode in which a synchronous connection-oriented (SCO) protocol is used. SCO protocol may, in particular, be suitable for exchanging real-time information such as audio or video data. In SCO, retransmissions are not used, but forward error correction may be supported.

BT devices 301, 303 within the network may include various circuits and components configured to receive and transmit communication signals. In various examples, BT devices 301, 303 within the network 300 may communicate according to BT technology performing operations according to BT protocol using one or more antennas 304, 305. The BT devices 301, 303 may further communicate according to further communication protocols as well. It is depicted in this example that each antenna 304, 305 as a single antenna but this may not be limiting. BT devices 301, 303 may include further antennas that are designated to be used for further radio communication technologies that a respective BT device may operate.

A multipoint BT device, as a type of a secondary device, may maintain more than one BT connection that are established with more than one further BT devices. The multipoint BT device may receive audio data stream from a first BT device over a communication link between the multipoint BT device and the first BT device, while exchanging information with further BT devices over communication links between the multipoint BT device and the further BT devices respectively, for example, by using the communication channel according to a TDD scheme.

FIG. 4 shows an exemplary illustration of a network topology that communication devices may use. Communication devices may be configured to communicate within a network 400 (e.g. a piconet for BT networks). Each communication device may undertake various roles within the network. For example, a communication device (e.g. BT device 301, further BT devices 303) may operate as a primary device 401 (e.g. master device, central device) or a secondary device 402 (e.g. slave device, peripheral device). A primary device 401 may be a communication device that may initiate a connection request to another communication device that advertises its presence. A secondary device 402 may be a communication device that receives a connection request from a primary device 401.

Each secondary device 402 may be communicatively coupled to the primary device over an established connection, collectively forming the network 400. The primary device 401 may coordinate communication through the network 400. It may be possible for the primary device 401 and the secondary devices 402 to change the roles in-between, such that the primary device 401 may become a secondary device and one of the secondary devices 402 may become a primary device in the network 400 in various examples. In various examples, the primary device 401 may establish and maintain an order and a polling scheme, including designating time slots for the secondary devices 402. The number of secondary devices 402 in the network may vary. Furthermore, the network 400 may be communicatively coupled to another network over at least one of the devices resulting in a scatternet for BT devices. In a scatternet, a device that may be a primary device or a secondary device for one network, may act as a secondary device for another network. In such cases, the device may employ time multiplexing to transmit/send radio communication signals to multiple networks.

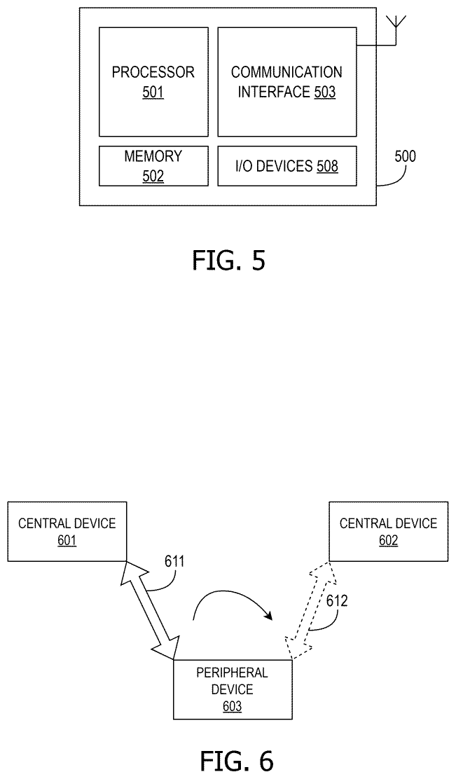

FIG. 5 shows an illustrative example of a communication device in accordance with various aspects described herein. The communication device 500 may include an apparatus including a processor 501. The processor 501 may include a central processing unit, a graphics processing unit, a hardware acceleration unit, a neuromorphic chip, and/or a controller. The processor 501 may be implemented in one processing unit, e.g. a system on chip (SOC), or an integrated system or chip. The processor 501 may include more than one processing unit configured to provide various aspects as mentioned herein. In various examples, the communication device 500 may be a communication device as described in this disclosure (e.g. BT device 301, 303), which may be acting as a central device (e.g. the primary device 401) or as a peripheral device (e.g. the secondary device 402). The processor 501 may be one or more processors of the communication device (e.g. application processor 212 and optionally protocol processor 210 and digital signal processor 208 as exemplarily provided with respect to FIG. 2).

The communication device 500 may further include a memory 502 to store data. The memory 502 may store an operating system (not shown) including instructions configured to manage various operations of the processor 501, the memory 502, and the communication interface 503, and may further manage operations of the communication device 500. The processor 501 and memory 502 (and also other various components of the apparatus) and other entities may be communicatively coupled over an internal interface to communicate with each other (e.g. a bus, wires, etc.).

The communication interface 503 may cause the communication device 500 to communicate with further communication devices configured for the same technology. The processor 501 may manage the communications with further communication devices for the communication device 500. The communication interface 503 various components, as exemplarily provided in accordance with FIG. 2, such as antenna system 202 including an antenna, radio frequency (RF) transceiver 204, baseband modem 206 (including digital signal processor 208 and protocol controller 210).

In various examples, the communication interface 503 may be configured to transmit and/or receive radio communication signals, via one or more antennas, according to BT communication protocol. The communication interface 503 may include a separate application processor, and memory, or in various examples, the processor 501 and the memory 502 may provide functions of an application processor and memory for communication purposes for the BT communication protocol. The communication interface 503 may further be configured to perform communications according to another communication protocol. Accordingly, the communication interface 503 may include multiple transceivers, each transceiver being configured to operate for a particular radio communication protocol.

In various examples in which the communication device 500 is a BT communication device, the processor 501 may perform BT host functions and BT controller functions of a BT protocol stack. The communication interface 503 may include a BT radio circuitry configured to transmit and/or receive BT radio communication signals. The processor 501 may execute and control execution of both BT host functions and BT controller functions within a BT protocol stack. BT host functions and BT controller functions include the essential operations for establishing and managing BT connections, handling protocols, and ensuring the smooth flow of data between interconnected BT devices. The communication interface 503 may transmit and receive BT radio communication signals, via a BT radio circuitry dedicated specifically to handle BT communication protocols.

The processor 501 may manage and oversee BT host functions and BT controller functions within its BT protocol stack. Illustratively, BT host functions may include the management of higher-level operations, such as establishing connections, authentication, encryption, and protocol handling. Through use of these functions, the BT communication device may provide seamless communication between BT-enabled devices, managing data transmission and reception. Meanwhile, BT controller functions may include the low-level functionalities responsible for managing radio frequencies, establishing links, and overseeing physical connections. These functions may optimize signal transmission, manage power consumption, and regulate the underlying hardware components for efficient BT connectivity.

The communication interface 503 may be configured to facilitate transmission and reception of radio communication signals adhering to the BT protocol via one or more antennas. The communication interface 503 may also include multiple transceivers, each configured for distinct radio communication protocols. This multifaceted setup may allow the BT communication device to engage not only in BT communication but also to adapt and communicate using other communication protocols as required.

In various examples, the communication interface 503 may be configured to transmit and/or receive communication signals according to a further communication technology (e.g. Ethernet, WLAN, cellular). The communication interface 503 and the processor 501 may be configured for the further communication technology. The communication interface 503 may include a separate application processor, and memory, or in various examples, the processor 501 and the memory 502 may provide functions of an application processor and memory for communication purposes for the further communication technology in accordance with a suitable communication protocol.

In some examples, the communication circuitry 503 may be configured to transmit and/or receive radio communication signals of different radio access technologies. Illustratively, the communication interface 503 may include a WLAN unit for WLAN communication, a BT unit for BT communication, and a cellular communication unit for cellular communication, and one or more further units for one or more further radio technologies.

The communication device 500 may further include one or more input and output (I/O) devices 508 that are communicatively coupled to the internal interface. It is depicted in the illustrative example that the communication device 500 includes I/O devices 508, however, this should not be taken as limiting, and the I/O devices 508 may be communicatively coupled to the communication device 500 via the communication interface 503.

The I/O devices 508 may include various components and devices to provide input to the communication device 500, in particular for the processor 501 to process received input to associate it for various instructions. The I/O devices 508 may include input devices that are designated based on the use case of the BT device including the communication device 500. In some examples, the I/O devices 508 may include a button. The provided input may include, in particular, an input associated with an interaction of a user using the respective input device. Exemplarily, a mouse may be one of the I/O devices 508 configured to deliver user interactions by moving a pointer via hand movements or pressing keys or a keyboard may be one of the I/O devices 508 delivering user interactions by receiving keystrokes, or a touchpad may be one of the I/O devices 508 delivering user interactions by receiving touch inputs, etc.

The I/O devices 508 may be configured to provide an output based on instructions executed by the processor 501. The I/O devices 508 may include output devices that are designated depending on the use case of the communication device 500. The provided output may include, in particular, an output to present various types of information or indications for a user. For example, a display may be one of the I/O devices 508 configured to display visual information to the user in form of images, text, pictures, videos, etc.

It should be noted that an I/O device may be both an input device and an output device for the BT device including the communication device 500 within this context. For example, one of the input/output devices 508 may include a display configured to provide a visual output to a user. Furthermore, the display may include a touch screen display that is configured to receive input from the user interacting with the display. The contact interaction from the user may be detected by a touch input unit. The touch input unit may be configured to detect the interaction of the user with the display via a contact of the user. The touch input unit may be configured to detect contact and/or movement of the user (e.g. via a finger, via a stylus, etc.,) while touching the display. Alternatively, the touch input unit may be configured to detect the interaction of the user via another defined surface. For example, the touch input may include a touchpad that is configured to receive input from the user. Accordingly, such a display may be both an example of an input device and an output device.

FIG. 6 shows an illustrative example of a system in accordance with various aspects described herein. The system includes a first central device 601, a second central device 602, and a peripheral device 603, each including a respective communication device as illustratively described in accordance with FIG. 5. Aspects described herein may refer to various components for the respective communication devices with their names. Illustratively, a processor (e.g. the processor 501) of a central device may be referred to as a central device processor, or a processor (e.g. the processor 501) of a peripheral device may be referred to as a peripheral device processor, and the like. Some of the aspects are described by distinguishing between the first central device 601 and second central device 602, referring to respective components, such as first central device processor and second central device processor, noting that a central device processor may be capable to perform aspects described for the first central device processor and the second central device processor.

In this illustration, a first established connection 611 is depicted between the peripheral device 603 and the first central device 601, which the first established connection 611 may be maintained in a first period of time in which the peripheral device 603 and the first central device 601 may communicate data to each other via the first established connection 611. In a second period of time, which may or may not overlap with the first period of time, the peripheral device 603 may communicate with the second central device 602 via a second established connection 612 between the peripheral device 603 and the second central device 602. In some aspects, the first central device 601 and the second central device 602 may also communicate with each other via a further established connection. The further established connection may also be a BT connection or a connection of another communication technology, such as WLAN, cellular, etc. Various aspects described herein may cause the peripheral device to switch from the first established connection 611 to the second established connection 612.

The central device processor (e.g., processor 501) may manage communication with the peripheral device 603 via the first established connection for a conventional data exchange operation with the peripheral device 603. The central device processor may maintain the connection, handle data exchanges, and ensure stable communication between the first central device 601 and the peripheral device 603.

In accordance with various aspects described herein, the central device processor may identify at least one further BT communication device (e.g. the first central device processor identifies the central device 602) that is connectable to the peripheral device 603. This identification process may involve scanning for nearby devices, evaluating their proximity, and determining their compatibility for connection.

For example, the central device processor may initiate a scanning process to detect nearby BT devices by activating a BT transceiver of the central device communication interface and setting it to scan mode. During this process, the central device processor may configure the transceiver to listen on specific BT channels designated for device discovery. The scan parameters, such as scan interval (how often the device scans) and scan window (the duration of each scan), may be set to optimize the balance between power consumption and the likelihood of detecting nearby devices. The central device processor may use either active scanning, where it sends inquiry requests and listens for responses, or passive scanning, where it simply listens for advertisement packets broadcasted by nearby devices. For a central device (e.g. the first central device 601) to identify other central devices (e.g. the second central device 602), other central devices may be configured to occasionally send out advertisement packets. These advertisement packets may contain essential information such as the device's name, address, capabilities, and roles (e.g., central device), which the central device processor may collect and store for further analysis. The advertisement packets may be broadcasted at regular intervals, allowing other devices in the vicinity to detect their presence.

In some examples, central device processors may be configured to implement respective application layer software allowing the central devices to exchange application layer data, which may include information to identify other central devices within a proximity. Illustratively, the first central device processor may receive application layer data from the second central device 602, which the application layer data may include an identifier of the second central device 602. The identifier may be any type of information that may identify the second central device 602, such as a UUID, a MAC Address, a BT Address, a device name, etc. In some examples, application layer data received from the central device 602 may further include a pairing code of the second central device 602 configured for a BT connection to be established. In some examples, received application layer data may further include a proximity information representative of a proximity (e.g. distance) of the second central device 602 to the first central device 601 or to the peripheral device 603.

The second central device processor may generate the paring code of the second central device 602 and/or the identifier and encode them for a transmission to the first central device 601 via the further established connection. In some examples, the application layer data may further include an indication to instruct the first central device processor to identify the second central device 602 as the further BT communication device as described herein and trigger the first central device processor to instruct the peripheral device 603 to enter a discovery mode and/or pair with the further BT communication device to establish a connection between the peripheral device 603 and the second central device 602.

In some examples, the central device processor may identify the further BT communication device based on the proximity of the further BT communication device to the central device and/or to the peripheral device. The central device processor may determine such proximities by any known method. Illustratively, the central device processor may receive application layer data indicative of the proximity. In some examples, the central device processor may determine respective distances between the central device and the peripheral device 603 and/or between the central devices (e.g. between the first central device 601 and the second central device 602) by a ranging operation, and/or based on one or more measurements on radio communication signals received from the respective devices.

For example, once the central device processor has detected nearby devices through scanning, the central device processor may evaluate their proximity using several metrics. One common method may include analyzing the Received Signal Strength Indicator (RSSI) values associated with the advertisement packets received from each other device. The RSSI may provide an estimate of the signal strength, which may correlate with the distance between the devices—the stronger the signal, the closer the device. The central device processor may also use techniques such as BLE beacons, which may include periodically broadcast signals that can be used to estimate proximity based on signal attenuation. Additionally, or alternatively, the central device processor may employ time-of-flight measurements, where the central device processor may calculate the time taken for a signal to travel to the corresponding device and back, providing a more precise distance estimate. In some examples, the central device may perform BT channel sounding (CS), which may also be referred to as high accuracy distance measurement (HADM). By aggregating these metrics, the central device processor may create a proximity profile for each detected device, helping to prioritize which devices are suitable for connection based on their distance.

In some examples, the central device processor may identify the further BT communication device based on a received user interaction. Illustratively, the user of the central device may interact through the I/O devices (e.g. the I/O devices 508) of the central device to indicate a selection of a further BT communication device among detected further BT communication devices. Illustratively, the first central device 601 may detect multiple central devices within the environment which are connectable to the peripheral device 603, and the user may provide instructions indicating the selection of the second central device 602, which the first central device processor may determine based on information provided by an input device of the I/O devices. In some examples, as described above, the information that triggers the first central device processor may be received from the second central device 602.

In some examples, the central device processor may further determine whether further BT communication devices are connectable to the peripheral device 603. The central device processor may determine compatibility of one or more detected further BT communication devices for a connection by analyzing the information received from their advertisement packets and performing additional checks if necessary. The central device processor may examine the device type, supported BT profiles (e.g., A2DP for audio streaming, HFP for hands-free communication), and version information to ensure that the detected device can support the desired functionalities for a connection with the peripheral device 603.

Since the further BT communication devices may be central devices, the central device processor may look for specific capabilities that enable coordination between central devices, such as support for multi-central connectivity protocols or specific software layers that facilitate seamless handover. The central device processor may check for security features, such as support for Secure Simple Pairing (SSP) or encryption capabilities, to ensure a secure connection. Additionally, the central device processor may reference a pre-stored list of compatible central devices or profiles to quickly identify suitable candidates. If received advertisement packets include an identifier (e.g. a service UUID), the central device processor may match the identifier against the required services to confirm compatibility. In some cases, the central device processor may initiate a brief exchange of additional information or perform a pairing procedure to verify that the detected further BT communication device meets all necessary criteria before triggering the instruction to the peripheral device to enter the discovery mode.

In some examples, the central device processor may also determine a particular type of pairing and/or discovery based on the determination of whether a detected further device is connectable to the peripheral device 603. Illustratively, at least one of the second central device 602 and the peripheral device 603 may support a particular type of pairing and/or discovery to establish a BT connection. For example, it may support a proprietary discovery and/or pairing mode, such as Microsoft Swiftpair, Google Fast Pair, or Samsung Quick Connect, and the first central device processor may determine the type and instruct the peripheral device 603 and/or the second central device 602 to use that particular type of pairing and/or discovery for a BT connection to be established between the peripheral device and the second central device 602.

In some examples, the second central device processor may also receive information from the first central device 601. For example, the second central device processor may decode information received from the first central device 601 over the further established connection, and the decoded information may indicate a presence of the peripheral device 603 to the second central device 602. Illustratively, the application layer data exchanged between the first central device 601 and the second central device 602 may include the information. In some examples, the decoded information may include a pairing code of the peripheral device 603 and/or an identifier of the peripheral device. In some examples, the first central device processor may send such information to the second central device 602 any time before instructing the peripheral device 603 to enter a discovery mode and/or pair with the further BT communication device, so that the second central device 602 may have necessary information to discover and pair the peripheral device 603 automatically. In some examples, the first central device processor may send such information substantially in a predefined period of time before or after instructing the peripheral device 603.

Correspondingly, the second central device processor may configure, in response to the information, its communication interface, through which the second central device 602 is to be connected with the peripheral device 603, to discover the peripheral device. In some examples, the first central device processor may also encode this information representative of the peripheral device 603 for transmission to the second central device 602, which may instruct the second central device 602 to enter a scanning mode for a period during which the peripheral device 603 is estimated to be in its discovery mode. By coordinating the discovery and scanning processes between the peripheral device 603 and the further BT communication device, the first central device processor may ensure a higher likelihood of successful connection establishment.

The central device processor may instruct the peripheral device 603 to enter a discovery mode and/or pair with the further BT communication device to establish a BT connection with the further BT communication device. Illustratively, the first central device processor may, in response to the identification of the second central device 602 and/or received user instruction and/or an information to trigger the instruction as described above, instruct the peripheral device 603 to enter a discovery mode via sending the instruction via the first established connection 611. The instruction may cause the peripheral device 603 to enter the discovery mode, in which the peripheral device processor may generate and encode advertisement packets for transmissions to be discovered by the second central device 602. The central device processor may encode information representing the instruction for a transmission to the peripheral device 603 via the first established connection 611.

In some examples, the information encoded for the transmission to the peripheral device 603 may indicate a presence of an identified further BT communication device. In some examples, the information may include an identifier of the further BT communication device (e.g. the second central device 602). The identifier may be any type of information that may identify the second central device 602, such as a UUID, a MAC Address, a BT Address, a device name, etc.

The first central device processor may also include a pairing code of the second central device 602 in the information to be transmitted to the peripheral device 603. This pairing code may be used for establishing a secure and authenticated connection between the peripheral device 603 and the second central device 602. In some examples, the pairing code may be the pairing code received from the second central device 602. In some examples, the first central device processor may generate the pairing code to be used to establish the connection between the second central device 602 and the peripheral device 603 and send it to the peripheral device 603 and also to the second central device 602.

Additionally, the first central device processor may determine the type of discovery mode to be entered by the peripheral device 603 based on the capabilities and requirements of the second central device 602, as described herein. For instance, if the second central device 602 supports a proprietary discovery mode, the first central device processor may include an indication of this type in the information transmitted to the peripheral device 603. This may ensure that the peripheral device 603 uses the appropriate discovery mode to facilitate a seamless connection with the second central device 602.

Once the peripheral device 603 receives the information from the first central device 601 indicating the instruction, the peripheral device 603 enters a discovery mode. Illustratively, the peripheral device processor may decode information received via the first established connection 611, which indicates a presence of the second central device 602. The peripheral device processor may, based on the information received via the first established connection 611, instruct the peripheral device 603 (e.g. instruct the communication interface of the peripheral device 603) to enter a discovery mode and/or pair with the further BT communication device. In the discovery mode, the peripheral device 603 may begin broadcasting advertisement packets that can be detected by the further BT communication device (e.g., the second central device 602). For this purpose, the peripheral device processor may encode the advertisement packets for transmission via the communication interface of the peripheral device 603.

In some examples, the peripheral device 603 may only operate in a connection mode by communicating via an established BT connection or in a discovery mode in which the peripheral device 603 may transmit advertisement packets. Correspondingly, the peripheral device processor may, in response to the received instruction from the first central device 601, disconnect the first established connection between the peripheral device 603 and the first central device 601. Furthermore, the peripheral device processor may prevent a reconnection to the first central device 601 for a period of time to prevent automatically pairing with the first central device 601 through the discovery mode. In some examples, the peripheral device processor may unpair the first central device 601 based on the instruction.

In some examples, the first central device processor may disconnect the first established connection 611 after instructing the peripheral device 603 to enter the discovery mode. In some examples, the first central device processor may manage the disconnection of the first established connection 611 once the peripheral device 603 successfully establishes a connection with the second central device 602. This may involve ensuring that the peripheral device 603 transitions smoothly from the first central device 601 to the second central device 602 without any loss of data or interruption in service.

To establish a BT connection that is depicted as the second established connection 612, both the second central device 602 and the peripheral device 603 may have obtained necessary information for discovery and pairing. The necessary information may include respective pairing codes to be used for the pairing and respective identifiers. Correspondingly, the second central device 602 may have obtained, via information received from the first central device 601, the pairing code and the identifier of the peripheral device 603. Similarly, the peripheral device 603 may have obtained, via information received from the first central device 601, the pairing code and the identifier of the second central device 602. Illustratively, the second central device processor and the peripheral device processor may use the obtained pairing codes and/or the identifiers during the initial connection setup or through a secure communication channel.

In accordance with various aspects described herein, the peripheral device processor may receive information from the first central device 601 that includes the pairing code of the second central device 602. The peripheral device processor may establish the further BT connection with the second central device 602 using this pairing code. The pairing code may serve as a security measure to authenticate the connection between the peripheral device 603 and the second central device 602. Upon receiving the pairing code, the peripheral device processor may initiate the connection establishing process by sending a connection request to the second central device 602, including the pairing code in the request. This may ensure that the connection is established securely and that both devices can communicate without any security breaches.

During the discovery mode, the peripheral device 603 may become discoverable at least by the second central device 602 and the peripheral device processor 603 may accept a pairing request received from the second central device 602 automatically based on the information within the pairing request and the pairing code and/or the identifier of the second central device 602. Illustratively, the peripheral device processor may instruct the peripheral device 603 to operate into a state where it actively broadcasts its presence and listens for incoming pairing requests. The first central device processor may ensure that the peripheral device 603 is configured to recognize and accept the pairing request from the second central device 602, using the previously generated and transmitted pairing code. This coordinated discovery and pairing process may ensure a seamless and secure connection between the peripheral device 603 and the second central device 602, facilitating efficient communication and data exchange.

Establishing a BT connection may involve several steps, during which identifiers and pairing codes may play crucial roles. During the discovery mode, the peripheral device 603 may broadcast advertisement packets that include unique identifiers such as BT Device Address (BD_ADDR), Universally Unique Identifier (UUID), and device names. These identifiers may help devices recognize each other. For instance, the second central device 602 may scan for advertisement packets from nearby devices. When the second central device processor detects an advertisement packet, the second central device processor may extract the identifier to determine if the device sending the advertisement packet is the peripheral device 603 based on the information received from the first central device 602 including the identifier of the peripheral device 603.

Establishing the BT connection may further include an initiation of connection, in which the second central device processor may use the identifier (e.g., BD_ADDR) of the peripheral device 603 to initiate a connection request. The second central device 602 may send a connection request packet to the peripheral device 603, including the peripheral device's identifier to indicate the target of the connection request. The peripheral device processor, upon receiving the connection request, may respond to establish a physical link.

Establishing the BT connection may further include a pairing process. In the pairing process, the peripheral device processor and the second central device processor may use pairing codes, such as Personal Identification Numbers (PINs), passkeys, or pairing keys, to authenticate and establish a secure connection. The peripheral device processor and/or the second central device processor may further generate a link key of the second established connection 612, which the link key may be derived from the pairing codes and other exchanged information. Memories of the peripheral device 603 and the second central device 602 may store the link key and may use the stored link key for future reconnections to authenticate and establish an encrypted link without repeating the pairing process. Furthermore, the establishing the BT connection may further include setting up the communication parameters, such as frequency hopping and time slots, to ensure a stable and reliable connection. Further steps may include performing mutual authentication, identifying services and profiles supported by the second central device 602 and the peripheral device 603, etc. After establishing the BT connection, the peripheral device 603 and the second central device 602 may operate as a pair and communicate data.

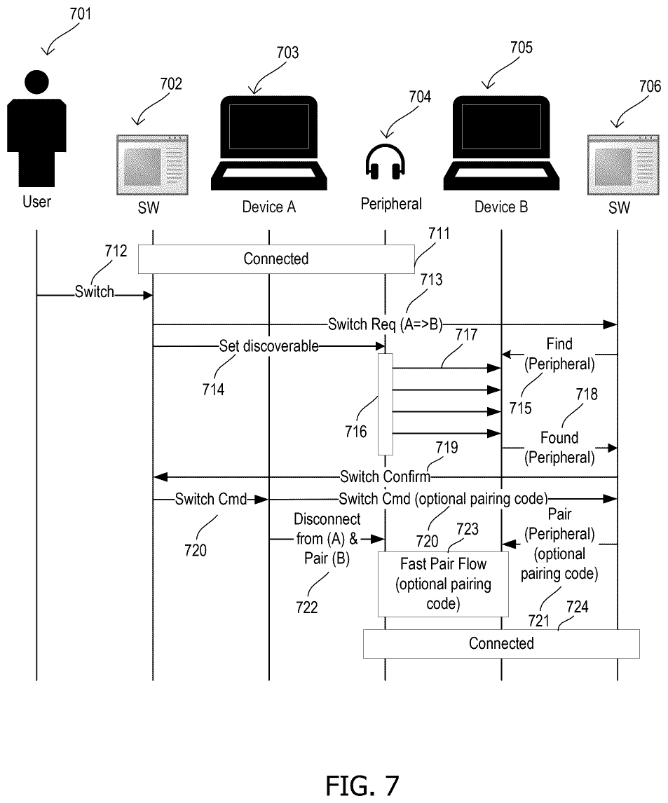

FIG. 7 shows an example of a flow chart to establish a new connection in a BT system including a first central device 703 (e.g. the first central device 601), depicted as Device A, a second central device 705 (e.g. the second central device 602), depicted as Device B, and a peripheral device 704 (e.g. the peripheral device 603). The first central device processor may implement an application layer software 702 and the second central device processor may implement another application layer software 706. A user 701 may interact with the first central device 601 through the application layer software 702.

The flowchart begins at a state in which there is an established BT connection 711 between the first central device 703 including its application layer software 702 and the peripheral device 704. At this stage, the first central device processor may have obtained necessary information (e.g. device identifiers, pairing codes, etc.) to instruct the peripheral device 704 and the second central device 705 to establish a BT connection in-between. In this state, the user 701 may initiate a flow to switch the BT connection of the peripheral device 704 from the first central device 703 to another device (e.g. the second central device).

Illustratively, the first central device processor may generate user output indicating a presence of a further connectable BT device that is connectable to the peripheral device 704. The first central device 703 may output the generated user output (e.g. displayed information on a display). The user 701 may, based on the generated output, provide user interactions 712 via an input device of the first central device 703 (e.g. via a keyboard or a mouse) to switch to the second central device 705. The first central device processor may provide the received user interaction to the application layer software 702 of the first central device 703.

Based on instructions of the application layer software 702, the first central device processor may encode switch request information 713, and the first central device 703 may, via its communication interface, send the switch request information to the second central device 705. The switch request information 713 may indicate a targeted switch event to the second central device 705. In some examples, the application layer software 702 of the first central device 703 may cause the first central device processor may check whether the second central device 705 is within a designated proximity, whether the application layer software 706 of the second central device 705 and/or the second central device 705 itself is compatible with the operation and/or is compatible with the peripheral device 704.

Illustratively, the switch request information may be application layer data and the second central device processor may provide the switch request information as application layer data to the application layer software 706 of the second central device 705. The switch request information may indicate a presence of the peripheral device 704 to which the second central device 705 is requested to establish a BT connection. In some examples, the switch request information may include information necessary for the second central device 705 to establish a BT connection with the peripheral device 704, which may illustratively include the identifier or the pairing code of the peripheral device 704. As described above, the first central device processor may have obtained the paring code and/or the identifier of the peripheral device 704 by generating them and/or by receiving from the peripheral device 704.

Furthermore, the first central device processor may encode a switch instruction 714, and the first central device 703 may transmit, via the established BT connection 711, the switch instruction to the peripheral device 704. The switch instruction 714 may instruct the peripheral device processor to enter a discovery mode and/or pair with the further BT communication device. The switch instruction 714 may indicate to the peripheral device 704 to send discovery frames so that the second central device 705 will be able to validate it can see the peripheral device 704. In some examples, the switch instruction 714 may instruct the peripheral device processor to disconnect the established BT connection 711 between the peripheral device 704 and the first central device 703 and unpair from the first central device 703. In some examples, the switch instruction 714 may further include necessary information for the peripheral device 704 to establish a new connection with the second central device 705. For example, the switch instruction 714 may include the identifier and/or the pairing code of the second central device 705. As described above, the first central device processor may have obtained the paring code and/or the identifier of the second central device 702 by generating them and/or by receiving from the second central device 705.

In response to received switch request information, the application layer software 706 of the second central device 705 may instruct 715 the second central device processor to cause the second central device 705 to operate in a scanning mode to listen for advertisement packets transmitted by the peripheral device 704. In a period of time overlapping with the activation of the scanning mode of the second central device 705, the peripheral device processor may cause the peripheral device 704 to enter a discovery mode 716, in which the second central device 705 may transmit its advertisement packets 717. As described herein, the discovery mode of the peripheral device 704 may cause the peripheral device 704 to identify, via a received response to the transmitted advertisement packets from the second central device 705, the second central device 705.

The second central device processor may provide information 718 indicating that the peripheral device has been found based on advertisement packets received during the scanning mode, which includes the advertisement packets 717. Based on this information, the application layer software 706 of the second central device 705 may generate information indicating at least one of i) the second central device 705 has discovered the peripheral device 704 and/or ii) the second central device 705 has initiated establishing a BT connection with the peripheral device 704. In some examples, the second central device 705 may generate the information as a confirmation of the established BT connection after step 724. The second central device 705 may send this information as a switch confirmation 719 to the first central device 703, and the first central device processor may provide this information to the application layer software 702 of the first central device 703. The application layer software 702 of the first central device 703 may cause the first central device 703 to send a switch command 720 to the application layer software 706 of the second central device 705, which causes the second central device 705 to initiate 721 the pairing with the peripheral device 704. In some examples, the switch command 720 may include the pairing code of the peripheral device 704 and the second central device 705 may initiate 721 the pairing using the pairing code of the peripheral device 704, illustratively by sending the pairing code to the peripheral device 704, so that the peripheral device 704 may authenticate the second central device 705. The first central device 703 and/or peripheral device 704 may disconnect 722 the established BT connection 711, and the second central device processor may also initiate the pairing with the second central device 705.

Both the peripheral device 704 and the second central device 705 may initiate the pairing 723 using the identifier and/or the pairing code of the second central device 705. Illustratively, the second central device processor may implement its pairing procedure 723 using the identifier and/or the pairing code of the peripheral device 704. The peripheral device processor may also implement its pairing procedure 723 using the identifier and/or the pairing code of the second central device 705. In various examples, the peripheral device processor may automatically pair with the second central device 705 based on the identifier and/or the pairing code of the second central device 705.

As described herein, the discovery mode 716 and the pairing procedure 723 may be a proprietary procedure, which the application layer software 706 may handle together with the peripheral device processor, such as Microsoft Swiftpair, Google Fast Pair, Samsung Quick Connect, etc. Illustratively, the peripheral device processor may initiate the discovery mode 716 in a manner in which the peripheral device processor accepts automatically the received connection request of the second central device 706. Illustratively, the peripheral device may disconnect the established BT connection 711 from the first central device 703 and automatically accept the pairing request of the second central device 704. In the pairing procedure, the second central device 705 may accept the pairing request and the second central device processor may authenticate the peripheral device 704 based on the pairing code of the peripheral device 704. Similarly, the peripheral device processor may authenticate the second central device 705 based on the pairing code of the second central device 705. Accordingly, a new BT connection 724 is established between the peripheral device 704 and the second central device 705.

In accordance with various aspects described herein, the BT technology used includes BLE, which has been initially introduced in the BT Core 4.0 specification. BLE may facilitate the transmission of smaller packets like sensor data as well. Its design emphasizes simplicity in the LE connection methodology. In a discovery procedure in BLE, in which secondary devices may perform advertising, while the central device may perform scanning; a connection establishment may occur when the LE host of the primary device attempts to connect to the advertising device. However, BT controllers may be considered to lack advanced handling to optimize connections between related BLE devices.

In accordance with various aspects described herein, the peripheral device processor may perform a BLE discovery procedure. In the BLE discovery procedure, the peripheral device 704 may transmit BLE communication signals including advertisement packets to advertise its presence to other communication devices within the radio environment (i.e. advertise it is connectable). In some examples, advertisement packets may be directed to all communication devices that can receive the advertisement packets or advertisement packets may be directed to a specific communication device.

In the BLE discovery procedure, the central device, such as the second central device 705, may initiate a scanning process in which the second central device processor may cause the communication interface of the second central device 705 to listen for advertisement packets. The second central device processor may determine scan parameters including a scan interval representing how often the second central device 705 performs the scanning, and a scan window representing a duration of time in which the communication interface actively listens for advertisement packets associated with the BLE discovery procedure.

The communication interface of the second central device 705 may detect incoming advertisement packets by detecting received packets matching a designated advertisement packet format. Illustratively, BLE controller functions of the second central device processor may cause the communication interface to perform the scan by switching to the designated advertising channels, and the BLE controller functions detects advertisement packets in these channels. Once the BLE controller functions identify an advertisement packet within the received BLE communication signal, the BLE controller may convert the BLE communication signal into digital data which may be referred to as a raw advertisement packet. BLE host functions of the second central device processor may decode the advertisement packet and obtain information within the advertisement packet. In some examples, the BLE host functions may generate an advertisement report representative of information provided with the advertisement packet and possibly further advertisement packets.

Accordingly, the second central device processor may identify the presence of the peripheral device 704 sending the advertisement packets. The second central device 705 may establish a connection with, or through an interaction of a user, or a received instruction, with the peripheral device 704. Illustratively, the second central processor may encode a connection request for a transmission to the peripheral device 704. The second central device processor may decode a connection response, received in response to the transmitted request, received from the peripheral device 704, and the second central device processor may establish the connection with the secondary device.

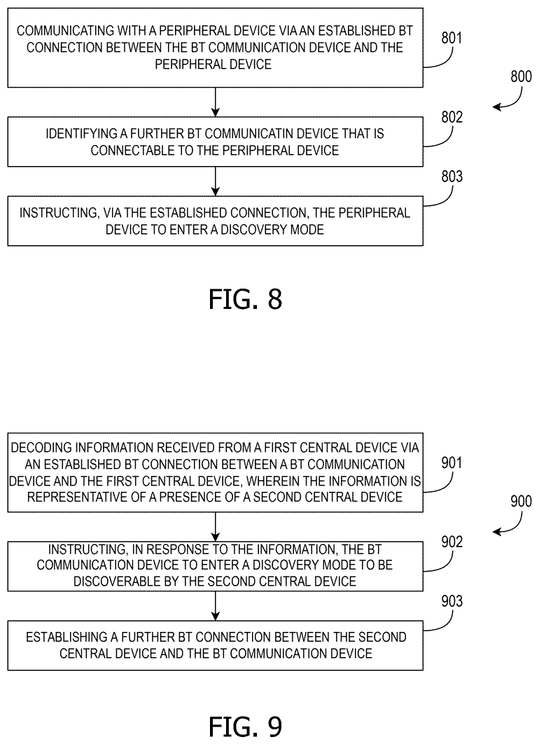

FIG. 8 shows an example of a method. The method 800 may include: communicating 801 with a peripheral device via an established BT connection between the BT communication device and the peripheral device; identifying 802 a further BT communication device that is connectable to the peripheral device; and instructing 803, via the established BT connection, the peripheral device to enter a discovery mode. A non-transitory computer-readable medium may include instructions which, if executed by a processor, cause the processor to perform the method.

FIG. 9 shows an example of a method for a BT communication device. The method 900 may include: decoding 901 information received from a first central device via an established BT connection between the BT communication device and the first central device, wherein the information is representative of a presence of a second central device; instructing 902, in response to the information, the BT communication device to enter a discovery mode to be discoverable by the second central device; establishing 903 a further BT connection between the second central device and the BT communication device. A non-transitory computer-readable medium may include instructions which, if executed by a processor, cause the processor to perform the method.

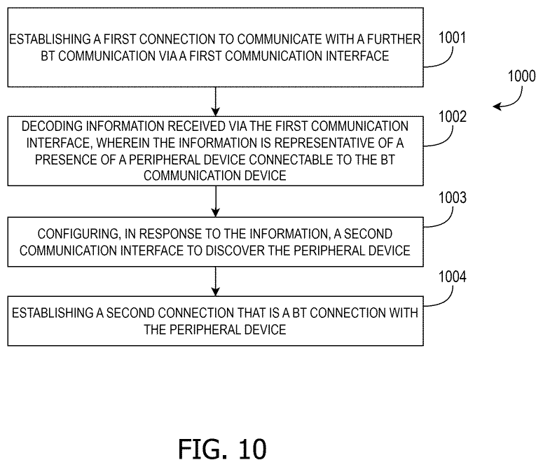

FIG. 10 shows an example of a method for a BT communication device. The method may include: establishing 1001 a first connection to communicate with a further BT communication device via a first communication interface; decoding 1002 information received via the first communication interface, wherein the information is representative of a presence of a peripheral device connectable to the BT communication device; configuring 1003, in response to the information, a second communication interface to discover the peripheral device; and establishing 1004 a second connection that is a BT connection with the peripheral device. A non-transitory computer-readable medium may include instructions which, if executed by a processor, cause the processor to perform the method.

The following examples pertain to further aspects of this disclosure.

In example 1, the subject matter includes an apparatus of a Bluetooth (BT) communication device, the apparatus including a memory and a processor. The processor is configured to communicate with a peripheral device through an established BT connection between the BT communication device and the peripheral device, identify a further BT communication device that is connectable to the peripheral device, and instruct, via the established BT connection, the peripheral device to enter a discovery mode and/or pair with the further BT communication device.

In example 2, the subject matter of example 1 may further include that the processor is further configured to encode information representative of the further BT communication device for transmission to the peripheral device.

In example 3, the subject matter of example 2 may further include that the processor is further configured to determine a pairing code of the further BT communication device, wherein the information further includes the pairing code of the further BT communication device.

In example 4, the subject matter of example 2 or example 3 may further include that the information includes an identifier of the further BT communication device, for identification by the peripheral device.

In example 5, the subject matter of any one of examples 2 to 4 may further include that the processor is further configured to determine the type of discovery mode to be entered by the peripheral device, wherein the information includes an indication of the type of the discovery mode.

In example 6, the subject matter of any one of examples 1 to 5 may further include that the processor is also configured to encode further information representative of the peripheral device, and this information is transmitted to the further BT communication device to instruct it to enter scanning mode for a period during which the peripheral device is estimated to be in discovery mode.

In example 7, the subject matter of example 6 may further include that the further information, or another information encoded for further transmission to the further BT communication device, includes a pairing code of the peripheral device, wherein the pairing code is received from the peripheral device.

In example 8, the subject matter of any one of examples 1 to 7 may further include that the processor is further configured to identify the further BT communication device based on its proximity.

In example 9, the subject matter of any one of examples 1 to 8 may further include that the processor is further configured to implement application layer software that identifies the further BT communication device by communicating application layer data with the further BT communication device, wherein the application layer software includes instructions that cause the processor to interact with a layer of a BT protocol stack implemented for the established BT connection to instruct the peripheral device to enter discovery mode.

In example 10, the subject matter of example 9 may further include that the application layer data includes a pairing code to pair with the peripheral device, wherein the pairing code is generated by the processor or received from the further BT communication device.

In example 11, the subject matter of any one of examples 1 to 10 may further include that the processor is further configured to disconnect the established BT connection after instructing the peripheral device to enter the discovery mode.

In example 12, the subject matter of any one of examples 1 to 11 may further include that the processor is further configured to instruct the peripheral device to enter discovery mode based on a received user interaction.

In example 13, the subject matter of example 12 may further include an input interface configured to receive user interaction information representative of the received user interaction, wherein the input interface is connectable to one or more input devices of the BT communication device.

In example 14, the subject matter of any one of examples 1 to 13 may further include that the processor is further configured to receive, from the further BT communication device, confirmation information representative of a presence of a further established BT connection between the peripheral device and the further BT communication device.

In example 15, the subject matter of any one of examples 1 to 14 may further include a BT transceiver configured to communicate with the peripheral device via the established BT connection.

In example 16, the subject matter includes an apparatus of a Bluetooth (BT) communication device, the apparatus including a memory and a processor configured to decode information received from a first central device via an established BT connection between the BT communication device and the first central device, wherein the information is representative of a presence of a second central device; instruct, in response to the information, the BT communication device to enter a discovery mode to be discoverable by the second central device and/or pair with the second central device; and establish a further BT connection between the second central device and the peripheral device.

In example 17, the subject matter of example 16 may further include that the processor is further configured to encode advertisement packets based on the information.

In example 18, the subject matter of example 16 or example 17 may further include that the processor is further configured to disconnect the established BT connection in response to identifying information representative of the presence of the second central device.

In example 19, the subject matter of any one of examples 16 to 18 may further include that the processor is further configured to prevent reconnection to the first central device until the further BT connection is established.

In example 20, the subject matter of any one of examples 16 to 19 may further include that the processor is further configured to cause the BT communication device to unpair the first central device based on the information.

In example 21, the subject matter of any one of examples 16 to 20 may further include that the information includes a pairing code of the second central device, and the processor is further configured to establish the further BT connection with the pairing code of the second central device.

In example 22, the subject matter of any one of examples 16 to 21 may further include that the information includes an identifier of the second central device, and the processor is further configured to initiate advertising based on the identifier of the second central device, to discover the second central device.

In example 23, the subject matter of any one of examples 16 to 22 may further include that the information includes an indication of the type of the discovery mode, and the processor is further configured to select the discovery mode to discover the second central device from multiple discovery modes based on the type indication.

In example 24, the subject matter of any one of examples 16 to 23 may further include that the processor is further configured to generate, before instructing the BT communication device to enter the discovery mode, a pairing code of the BT communication device to pair with the second central device, and encode the passcode for transmission to the first central device.

In example 25, the subject matter of any one of examples 16 to 24 may further include that the processor is configured to, during the discovery mode, cause the BT communication device to be discoverable at least by the second central device, and to accept a pairing request received from the second central device.

In example 26, the subject matter of any one of examples 16 to 25 may further include that the processor is further configured to disconnect the established BT connection before instructing the BT communication device to enter the discovery mode.

In example 27, the subject matter of any one of examples 16 to 26 may further include a BT transceiver configured to communicate with the first central device via the established BT connection.

In example 28, the subject matter includes an apparatus of a BT communication device, the apparatus including a memory and a processor configured to establish a first connection to communicate with a further BT communication device via a first communication interface; decode information received via the first communication interface, wherein the information is representative of a presence of a peripheral device connectable to the BT communication device; configure, in response to the information, a second communication interface to discover the peripheral device; and establish a second connection that is a BT connection with the peripheral device.

In example 29, the subject matter of example 28 may further include that the processor is further configured to generate a pairing code of the BT communication device and encode the pairing code for transmission to the further BT communication device.

In example 30, the subject matter of example 28 or example 29 may further include that the decoded information or a further information received from the further BT communication device includes a pairing code of the peripheral device, and the processor is further configured to establish the second connection using the pairing code of the peripheral device.

In example 31, the subject matter of any one of examples 28 to 30 may further include that the processor is further configured to implement application layer software to communicate with the further BT communication device by exchanging application layer data with it, wherein the application layer software includes instructions to cause the processor to interact with a layer of a BT protocol stack to configure the second communication interface to discover the peripheral device and/or to establish the second connection.

In example 32, the subject matter of any one of examples 28 to 31 may further include that the application layer data includes a received pairing code to pair with the peripheral device from the further BT communication device.

In example 33, the subject matter includes a method for a Bluetooth (BT) communication device, the method including: communicating with a peripheral device via an established BT connection between the BT communication device and the peripheral device; identifying a further BT communication device that is connectable to the peripheral device; and instructing, via the established BT connection, the peripheral device to enter a discovery mode and/or pair with the further BT communication device.

In example 34, the subject matter of example 33 further includes encoding information representative of the further BT communication device for transmission to the peripheral device.

In example 35, the subject matter of example 34 further includes determining a pairing code of the further BT communication device, wherein the information further includes the pairing code of the further BT communication device.

In example 36, the subject matter of example 34 or example 35, wherein the information includes an identifier of the further BT communication device for identification by the peripheral device.

In example 37, the subject matter of any one of examples 34 to 36 further includes determining a type of discovery mode to be entered by the peripheral device, wherein the information includes an indication of the type of the discovery mode.

In example 38, the subject matter of any one of examples 33 to 37 further includes encoding further information representative of the peripheral device for transmission to the further BT communication device to instruct the further BT communication device to enter a scanning mode for a period of time in which the peripheral device is estimated to be in the discovery mode.

In example 39, the subject matter of example 38, wherein the further information or another information encoded for further transmission to the further BT communication device includes a pairing code of the peripheral device, wherein the pairing code is received from the peripheral device.

In example 40, the subject matter of any one of examples 33 to 39 further includes identifying the further BT communication device based on its proximity.

In example 41, the subject matter of any one of examples 33 to 40 further includes implementing application layer software configured to identify the further BT communication device by communicating application layer data with the further BT communication device, wherein the application layer software includes instructions to cause interaction with a BT protocol stack implemented for the established BT connection to instruct the peripheral device to enter the discovery mode.

In example 42, the subject matter of example 41, wherein the application layer data includes a pairing code to pair with the peripheral device, wherein the pairing code is generated by the processor or received from the further BT communication device.

In example 43, the subject matter of any one of examples 33 to 42 further includes disconnecting the established BT connection after instructing the peripheral device to enter the discovery mode.

In example 44, the subject matter of any one of examples 33 to 43 further includes instructing the peripheral device to enter the discovery mode based on a received user interaction.

In example 45, the subject matter of example 44 further includes receiving user interaction information representative of the received user interaction through an input interface connectable to one or more input devices of the BT communication device.

In example 46, the subject matter of any one of examples 33 to 45 further includes receiving confirmation information from the further BT communication device representative of a presence of a further established BT connection between the peripheral device and the further BT communication device.

In example 47, the subject matter of any one of examples 33 to 46 further includes communicating with the peripheral device via a BT transceiver through the established BT connection.

In example 48, the subject matter includes a method for a Bluetooth (BT) communication device, the method including: decoding information received from a first central device via an established BT connection between the BT communication device and the first central device, wherein the information is representative of a presence of a second central device; instructing, in response to the information, the BT communication device to enter a discovery mode to be discoverable by the second central device and/or pair with the second central device; establishing a further BT connection between the second central device and the BT communication device.

In example 49, the subject matter of example 48 further includes encoding advertisement packets based on the information.

In example 50, the subject matter of example 48 or example 49 further includes disconnecting the established BT connection in response to identifying that the information is representative of the presence of the second central device.

In example 51, the subject matter of any one of examples 48 to 50 further includes preventing reconnection to the first central device until the further BT connection is established.

In example 52, the subject matter of any one of examples 48 to 51 further includes causing the BT communication device to unpair the first central device based on the information.

In example 53, the subject matter of any one of examples 48 to 52, wherein the information further includes a pairing code of the second central device, and further includes establishing the further BT connection with the pairing code of the second central device.

In example 54, the subject matter of any one of examples 48 to 53, wherein the information further includes an identifier of the second central device, further including initiating advertising based on the identifier of the second central device to discover the second central device.

In example 55, the subject matter of any one of examples 48 to 54, wherein the information includes an indication of the type of the discovery mode, further including selecting the discovery mode to discover the second central device from a plurality of discovery modes based on the indication of the type of the discovery mode.

In example 56, the subject matter of any one of examples 48 to 55 further includes generating, before instructing to enter the discovery mode, a pairing code of the BT communication device to pair with the second central device, and encoding the passcode for transmission to the first central device.

In example 57, the subject matter of any one of examples 48 to 56, during the discovery mode, causes the BT communication device to be discoverable at least by the second central device and to accept a pairing request received from the second central device.

In example 58, the subject matter of any one of examples 48 to 57 further includes disconnecting the established BT connection before instructing to enter the discovery mode.

In example 59, the subject matter of any one of examples 48 to 58 further includes communicating with the first central device via a BT transceiver through the established BT connection.

In example 60, the subject matter includes a method for a Bluetooth (BT) communication device, the method including: establishing a first connection to communicate with a further BT communication device via a first communication interface; decoding information received via the first communication interface, wherein the information is representative of a presence of a peripheral device connectable to the BT communication device; configuring, in response to the information, a second communication interface to discover the peripheral device; and establishing a second connection that is a BT connection with the peripheral device.

In example 61, the subject matter of example 60 further includes generating a pairing code of the BT communication device and encoding the pairing code for transmission to the further BT communication device.

In example 62, the subject matter of example 60 or example 61 further includes decoding information or further information received from the further BT communication device including a pairing code of the peripheral device, and establishing the second connection using the pairing code of the peripheral device.

In example 63, the subject matter of any one of examples 60 to 62 further includes implementing application layer software configured to communicate with the further BT communication device by communicating application layer data with the further BT communication device, wherein the application layer software includes instructions to interact with a BT protocol stack to configure the second communication interface to discover the peripheral device and/or to establish the second connection.

In example 64, the subject matter of any one of examples 60 to 63, wherein the application layer data includes a received pairing code from the further BT communication device to pair with the peripheral device.

In example 65, the subject matter includes a non-transitory computer-readable medium including instructions that, when executed by a processor of a Bluetooth (BT) communication device, cause the processor to: communicate with a peripheral device via an established BT connection between the BT communication device and the peripheral device; identify a further BT communication device that is connectable to the peripheral device; and instruct, via the established BT connection, the peripheral device to enter a discovery mode and/or pair with the further BT communication device.

In example 66, the subject matter of example 65, further includes instructions that cause the processor to encode information representative of the further BT communication device for transmission to the peripheral device.

In example 67, the subject matter of example 66, further includes instructions that cause the processor to determine a pairing code of the further BT communication device, wherein the information further includes the pairing code of the further BT communication device.

In example 68, the subject matter of example 66 or example 67, further includes instructions that cause the processor to include an identifier of the further BT communication device for identification by the peripheral device.

In example 69, the subject matter of any one of examples 66 to 68, further includes instructions that cause the processor to determine a type of discovery mode to be entered by the peripheral device, wherein the information includes an indication of the type of the discovery mode.

In example 70, the subject matter of any one of examples 65 to 69, further includes instructions that cause the processor to encode further information representative of the peripheral device for transmission to the further BT communication device to instruct the further BT communication device to enter a scanning mode for a period of time in which the peripheral device is estimated to be in the discovery mode.

In example 71, the subject matter of example 70, further includes instructions that cause the processor to encode further information or another information for further transmission to the further BT communication device, including a pairing code of the peripheral device received from the peripheral device.

In example 72, the subject matter of any one of examples 65 to 71, further includes instructions that cause the processor to identify the further BT communication device based on its proximity.

In example 73, the subject matter of any one of examples 65 to 72, further includes instructions to implement application layer software configured to identify the further BT communication device by communicating application layer data with the further BT communication device, wherein the application layer software includes instructions to interact with a BT protocol stack implemented for the established BT connection to instruct the peripheral device to enter the discovery mode.

In example 74, the subject matter of example 73, further includes instructions that cause the processor to utilize application layer data, including a pairing code to pair with the peripheral device, whether generated by the processor or received from the further BT communication device.

In example 75, the subject matter of any one of examples 65 to 74, further includes instructions that cause the processor to disconnect the established BT connection after instructing the peripheral device to enter the discovery mode.

In example 76, the subject matter of any one of examples 65 to 75, further includes instructions that cause the processor to instruct the peripheral device to enter the discovery mode based on a received user interaction.

In example 77, the subject matter of example 76, further includes instructions that cause the processor to receive user interaction information representative of the received user interaction through an input interface connectable to one or more input devices of the BT communication device.

In example 78, the subject matter of any one of examples 65 to 77, further includes instructions that cause the processor to receive confirmation information from the further BT communication device representative of a presence of a further established BT connection between the peripheral device and the further BT communication device.

In example 79, the subject matter of any one of examples 65 to 78, further includes instructions that cause the processor to communicate with the peripheral device via a BT transceiver through the established BT connection.

In example 80, the subject matter includes a non-transitory computer-readable medium including instructions that, when executed by a processor of a Bluetooth (BT) communication device, cause the processor to: decode information received from a first central device via an established BT connection between the BT communication device and the first central device, wherein the information is representative of a presence of a second central device; instruct, in response to the information, the BT communication device to enter a discovery mode to be discoverable by the second central device and/or pair with the second central device; establish a further BT connection between the second central device and the BT communication device.

In example 81, the subject matter of example 80, further includes instructions that cause the processor to encode advertisement packets based on the information.

In example 82, the subject matter of example 80 or example 81, further includes instructions that cause the processor to disconnect the established BT connection upon identifying that the information is representative of the presence of the second central device.

In example 83, the subject matter of any one of examples 80 to 82, further includes instructions that cause the processor to prevent reconnection to the first central device until the further BT connection is established.

In example 84, the subject matter of any one of examples 80 to 83, further includes instructions that cause the processor to unpair from the first central device based on the information.

In example 85, the subject matter of any one of examples 80 to 84, further includes instructions that cause the processor to use a pairing code of the second central device to establish the further BT connection with the pairing code of the second central device.

In example 86, the subject matter of any one of examples 80 to 85, further includes instructions that cause the processor to initiate advertising based on an identifier of the second central device to discover the second central device.

In example 87, the subject matter of any one of examples 80 to 86, further includes instructions that cause the processor to select the discovery mode to discover the second central device from a plurality of discovery modes based on an indication of the type of the discovery mode.

In example 88, the subject matter of any one of examples 80 to 87, further includes instructions that cause the processor to generate a pairing code of the BT communication device to pair with the second central device, and encode the passcode for transmission to the first central device before instructing the device to enter discovery mode.

In example 89, the subject matter of any one of examples 80 to 88, further includes instructions that cause the processor to, during the discovery mode, make the BT communication device discoverable by at least the second central device and to accept a pairing request received from the second central device.

In example 90, the subject matter of any one of examples 80 to 89, further includes instructions that cause the processor to disconnect the established BT connection before instructing the device to enter discovery mode.

In example 91, the subject matter of any one of examples 80 to 90, further includes instructions that cause the processor to communicate with the first central device via a BT transceiver through the established BT connection.

In example 92, the subject matter includes a non-transitory computer-readable medium including instructions that, when executed by a processor of a Bluetooth (BT) communication device, cause the processor to: establish a first connection to communicate with a further BT communication device via a first communication interface; decode information received via the first communication interface, wherein the information is representative of a presence of a peripheral device connectable to the BT communication device; configure, in response to the information, a second communication interface to discover the peripheral device; and establish a second connection that is a BT connection with the peripheral device.

In example 93, the subject matter of example 92, further includes instructions that cause the processor to generate a pairing code of the BT communication device and encode the pairing code for transmission to the further BT communication device.

In example 94, the subject matter of example 92 or example 93, further includes instructions that cause the processor to decode information or further information received from the further BT communication device, including a pairing code of the peripheral device, and establish the second connection using the pairing code of the peripheral device.

In example 95, the subject matter of any one of examples 92 to 94, further includes instructions that cause the processor to implement application layer software configured to communicate with the further BT communication device by communicating application layer data with the further BT communication device, wherein the application layer software includes instructions to interact with a BT protocol stack to configure the second communication interface to discover the peripheral device and/or to establish the second connection.

In example 96, the subject matter of any one of examples 92 to 95, further includes instructions that cause the processor to use application layer data including a received pairing code from the further BT communication device to pair with the peripheral device.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

As used herein, “communication device” (e.g. a radio communication device) may refer to any type of electronic devices that are able to exchange information with at least another device, for example according to various types of radio communication technologies and using various types of communication protocols as exemplarily provided herein. Exemplarily, a communication device may be, or may include, an access point, a station, any types of user devices which may include a suitable device including a processor, that may include, a mobile device or a non-mobile device, a user equipment (UE), a computing device, such as a personal computer (PC), a desktop computer, a mobile computer, a laptop computer, a notebook computer, a tablet computer, a server, a handheld computing device, a wearable device, such as a smart bracelet, a smart watch, smart glasses, a smart ring, etc., an internet of things (IoT) device, a sensor, a mobile phone, a cellular telephone, any types of wireless accessories, such as a headphone, a headset, a microphone, a speaker, a domotics (smart home) device, a docking station, a medical device, an endoscope, a surgical robot, a hearing aid, a cochlear implant device or a system, a Bluetooth medical device, an audio communication device, a headset, a headphone, an earphone, an earbud, a true wireless earphone, a wireless speaker, an in-vehicle device, or a device for vehicles, etc.

As used herein, the term “peripheral device” may refer to any device that can communicate with a BT communication device. Peripheral devices may typically connect to one or more central devices and may send and receive data via one or more established BT connections. Examples of peripheral devices include wireless headphones, speakers, keyboards, mice, smartwatches, fitness trackers, and various other IoT devices. Illustratively, a peripheral device can enter a discovery mode, be paired with Bluetooth communication devices using a pairing code, and may generate unique identifiers to allow BT communication devices to identify the peripheral device by generated unique identifiers. The central device can manage connections with these peripherals through a Bluetooth protocol stack, ensuring seamless interaction and communication. In some aspects, peripheral devices may be referred to as secondary devices.

As used herein, the term “central device” may refer to a device that is connected to one or more other devices via an established BT connection. A central device may typically manage and coordinate communication with peripheral devices, initiate connections and maintain control over the data exchange process between connected peripheral devices and the central device. Central devices may be often more powerful and capable in terms of processing and resource management compared to the peripheral devices they connect to. Examples of central devices may include smartphones, tablets, laptops, and desktop computers. These devices frequently connect to peripherals like wireless headphones, keyboards, mice, and fitness trackers to enable various functionalities and data exchanges. In a Bluetooth ecosystem, the central device often acts as the main hub that facilitates seamless interactions and connections with multiple peripherals.

The term “discovery mode” is used herein to refer to any type of discovery that can be initiated by a peripheral device. In the context of BT technology, “discovery mode” may refer to a state that can be initiated by a peripheral device to make itself detectable (i.e. discoverable) by other Bluetooth devices, such as central devices. When a peripheral device enters discovery mode, the peripheral device may actively advertise its presence by transmitting information such as its device name, address, capabilities, and other identifying details. This may allow other Bluetooth devices within range to identify and recognize the peripheral, facilitating pairing and connection processes. The discovery mode may be considered as essential for the initial setup and configuration of Bluetooth connections, enabling devices to locate and authenticate each other.

A “pairing code” designates a code that is used to identify a device that is connectable to a Bluetooth communication device. In the context of the BT technology, a “pairing code” may correspond to a code that may be used to identify a BT device, which may be a central device or a peripheral device, which is connectable to a further Bluetooth communication device. This code may be employed during the pairing process to establish a secure connection between BT devices and to ensure that both BT devices are authenticated and authorized to communicate with each other. The pairing code can be generated by one of the devices or received from another device and may be used to prevent unauthorized access. Through use of pairing codes, BT devices may facilitate the setup of a secure link by enabling encryption, thereby protecting the data exchanged over the Bluetooth connection. A pairing code as described herein may be in various forms and may include a numeric code, an alphanumeric code, a personal identification number (PIN), a passkey, etc.

An “established BT connection” may refer to a connection between two BT communication devices, illustratively between a central device and a peripheral device. For example, it may be a connection between BT devices, which has been successfully set up by a central device. An established BT connection may imply that both BT devices have undergone a discovery and pairing process, authenticated one another (often using a pairing code), and are able to communicate and exchange data securely. The BT connection may indicate not only the mutual recognition, by BT devices at two ends of the connection, of the other's presence but also the establishment of a reliable communication channel, which may enable various functionalities such as data transfer, audio streaming, and control commands.

As used herein, the term “application layer software” may refer to any program or instruction that may cause a processor to interact with a layer of a BT protocol stack, which the interaction may include facilitating tasks such as identifying additional BT communication devices, instructing peripherals to enter discovery mode, and managing the establishment of BT connections. Application layer software may operate at the highest layer of the network protocol stack, provide end-user services and enable user applications to interact with the underlying network and its protocols. In various aspects described herein, application layer software may be configured to communicate with Bluetooth (BT) communication devices by sending and receiving application layer data. This software comprises instructions to cause the processor to interact with a layer of the BT protocol stack, thus facilitating tasks such as identifying additional BT communication devices, instructing peripherals to enter discovery mode, and managing the establishment of BT connections.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered the same signal. For example, a transmit signal may be considered as referring to the transmit signal in baseband, intermediate, and radio frequencies.

Similarly, as used herein, data may be transmitted or conducted through a data chain in which the data is processed to change characteristics via encoding and/or decoding operations, arrangement of data packets (e.g. data packets in various layers of protocol stack), and so on. The data may be referred to as the same data even as such characteristics are adapted. In general, so long as a data continues to carry the same information, the data may be considered as the data signal. For example, audio data may be considered as referring to an audio signal, a pre-processed audio data obtained from the audio signal, encoded audio signal, or encoded pre-processed audio data, unless explicitly specified.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

All acronyms defined in the above description additionally hold in all claims included herein.

What is claimed is:

1. An apparatus of a Bluetooth (BT) communication device, the apparatus comprising a memory, and a processor configured to:
communicate with a peripheral device via an established BT connection between the BT communication device and the peripheral device;
identify a further BT communication device that is connectable to the peripheral device; and
instruct, via the established BT connection, the peripheral device to enter a discovery mode.

2. The apparatus of claim 1,
wherein the processor is further configured to encode information representative of the further BT communication device for a transmission to the peripheral device.

3. The apparatus of claim 2,
wherein the processor is further configured to determine a pairing code of the further BT communication device; and
wherein the information further comprises the pairing code of the further BT communication device.

4. The apparatus of claim 2,
wherein the information comprises an identifier of the further BT communication device for an identification of the further BT communication by the peripheral device.

5. The apparatus of claim 1,
wherein the processor is further configured to encode further information representative of the peripheral device for a transmission to the further BT communication device to instruct the further BT communication device to enter a scanning mode for a period of time in which the peripheral device is estimated to be in the discovery mode.

6. The apparatus of claim 5,
wherein the further information or another information encoded for a further transmission to the further BT communication device comprises a pairing code of the peripheral device, wherein the pairing code is received from the peripheral device.

7. The apparatus of claim 1,
wherein the processor is further configured to identify the further BT communication device based on a proximity to the further BT communication device.

8. The apparatus of claim 1,
wherein the processor is further configured to instruct the peripheral device to enter the discovery mode based on a received user interaction.

9. An apparatus of a Bluetooth (BT) communication device, the apparatus comprising a memory, and a processor configured to:
decode information received from a first central device via an established BT connection between the BT communication device and the first central device, wherein the information is representative of a presence of a second central device;
instruct, in response to the information, the BT communication device to enter a discovery mode to be discoverable by the second central device; and
establish a further BT connection with the second central device.

10. The apparatus of claim 9,
wherein the processor is further configured to disconnect the established BT connection in response to an identification of the information being representative of the presence of the second central device.

11. The apparatus of claim 9,
wherein the processor is further configured to prevent a reconnection to the first central device until the further BT connection is established.

12. The apparatus of claim 9,
wherein the processor is further configured to cause the BT communication device to unpair the first central device based on the information.

13. The apparatus of claim 9,
wherein the processor is further configured to generate, before instructing to enter the discovery mode, a pairing code to pair with the second central device, and encode the passcode for a transmission to the first central device.

14. The apparatus of claim 9,
wherein the processor is further configured to disconnect the established BT connection before instructing to enter the discovery mode.

15. The apparatus of claim 9, further comprising a BT transceiver configured to communicate with the first central device via the established BT connection.

16. An apparatus of a BT communication device, the apparatus comprising a memory, and a processor configured to: establish a first connection to communicate with a further BT communication device via a first communication interface;
decode information received via the first communication interface, wherein the information is representative of a presence of a peripheral device connectable to the BT communication device;
configure, in response to the information, a second communication interface to discover the peripheral device; and
establish a second connection that is a BT connection with the peripheral device.

17. The apparatus of claim 16,
wherein the processor is further configured to generate a pairing code of the BT communication device and encode the pairing code for a transmission to the further BT communication device.

18. The apparatus of claim 16,
wherein the decoded information or a further information received from the further BT communication device comprises a pairing code of the peripheral device; wherein the processor is further configured to establish the second connection using the pairing code of the peripheral device.

19. The apparatus of claim 16,
wherein the processor is further configured to implement an application layer software configured to communicate with the further BT communication device by communicating application layer data with the further BT communication device; and
wherein the application layer software comprises instructions to cause the processor to interact with a layer of a BT protocol stack to configure the second communication interface to discover the peripheral device and/or to establish the second connection.

20. The apparatus of claim 19,
wherein the application layer data comprises a received pairing core to pair with the peripheral device from the further BT communication device.
